(19) United States
(12) Patent Application Publication
(10) Pub. No.: US 2009/0183694 A1
(43) Pub. Date: Jul. 23, 2009

(54) System and method for crevice cleaning in steam generators

(75) Inventors: John F. Remark, Lynchburg, VA (US); Sarah E. Evans, Lynchburg, VA (US)

Correspondence Address: Davidson, Davidson & Kappel, LLC, 485 7th Avenue, 14th Floor, New York, NY, 10018, US

(73) Assignee: AREVA NP INC., Lynchburg, VA (US)

(21) Appl. No.: 12/009,388

(22) Filed: Jan. 18, 2008

(51) Int. Cl. F22B 37/52; B08B 9/02; B08B 3/08; B08B 3/10; B08B 3/04; F28G 9/00; F22B 37/48

(52) U.S. Cl. 122/396; 165/95; 122/379; 134/3; 134/195; 134/108

(57) ABSTRACT

A method is provided for cleaning crevices between a plurality of tubes and a plurality of tube support plates supporting the tubes in a steam generator. The steps include filling a secondary side of the steam generator with a solvent to a first level above a first tube support plate to be cleaned, draining the solvent to a second level lower than the first tube support plate, and refilling the secondary side of the steam generator with the solvent to a third level above the first tube support plate. A cleaning system is also provided.

### BACKGROUND

The present invention relates generally to steam generators in nuclear power plants, and more specifically to cleaning crevices between steam generator tubes and tube support plates.

As discussed in, “Designing a Chemical Cleaning System A Conceptual Design” by W. A. Hudson, J. B. Delrue, S. E. Evans and J. F. Remark corrosion products deposited in the secondary side of steam generators may be detrimental to both the steam generator and steam generator tubes. For example, copper and iron from piping and feedwater systems may be deposited on tube support plates, tubes and in crevices between the tube support plates and tubes in the secondary side of steam generators. The deposits may be harmful to the steam generator and steam generator tubes by inducing tube degradation such as stress corrosion cracking and tube denting. The deposits also can reduce efficiency of the steam generator.

“Designing a Chemical Cleaning System A Conceptual Design” discloses a crevice cleaning step applied at elevated temperatures (i.e., >200° F. or 93° C.) under a nitrogen overpressure. Nitrogen is used in this process step to eliminate oxygen ingress and to pressurize the system to suppress boiling of the crevice solution until the system is vented. Boiling of the solution provides mechanical agitation of the solution which replenishes the solvent in the crevice regions for improved dissolution.

“Secondary Side Chemical Cleaning of Steam Generators of Pressurized Water Reactors” by Ursula Hollwedel discloses, for example, using one solvent after another to complete a chemical cleaning process. An iron solvent, copper solvent then crevice cleaning solvent is used. The application of solvents takes place during an outage and after the steam generators have been drained following shutdown of the reactor.

U.S. Pat. No. 5,601,657 discloses a first cleaning liquid used to remove a majority of the accumulated sludge and deposits from the surfaces of the heat exchanger, and a second cleaning liquid used to remove deposits from the crevice regions of the heat exchanger. Boiling may be induced in the crevices between the tubes and the tube support plates by venting of the secondary side while heating through the primary side of the heat exchanger. Repeated venting as the water level is lowered results in crevice boiling at each tube support plate.

### SUMMARY OF THE INVENTION

Venting is disadvantageous because regulations limit or prevent the amount of gases, for example, ammonia, that may be released into the environment. Furthermore, obtaining permits needed for the release of gases may be required which are expensive and time consuming. Additional disadvantages associated with venting include environmental concerns related to the release of gases. An object of the present invention is to provide a crevice cleaning system and method which reduces venting requirements.

The present invention provides a method for cleaning crevices between a plurality of tubes and a plurality of tube support plates supporting the tubes in a steam generator including the steps of:

filling a secondary side of the steam generator with a solvent to a first level above a first tube support plate to be cleaned;

draining the solvent to a second level lower than the first tube support plate; and

refilling the secondary side of the steam generator with the solvent to a third level above the first tube support plate.

The present invention further provides a cleaning system for cleaning crevices between a plurality of tubes and a plurality of tube support plates supporting the tubes in a steam generator including:

at least one inlet and at least one outlet connected to the steam generator for filling a secondary side of the steam generator to a first level above a tube support plate and draining the secondary side of the steam generator to a second level below the tube support plate respectively;

a closed solvent loop;

a storage reservoir for adding and removing the solvent from the closed solvent loop to alter the level of the solvent in the secondary side of the steam generator; and

a recirculation pump pumping the solvent through the cleaning system.

### BRIEF DESCRIPTION OF THE DRAWINGS

One preferred embodiment of the present invention will be described with respect to the drawing in which:

FIG. 1 shows a cleaning system for a steam generator in a pressurized water reactor in accordance with the present invention; and

FIGS. 2, 3 and 4 show schematically crevices to be cleaned by the cleaning system in FIG. 1.

### DETAILED DESCRIPTION OF THE PREFERRED EMBODIMENT

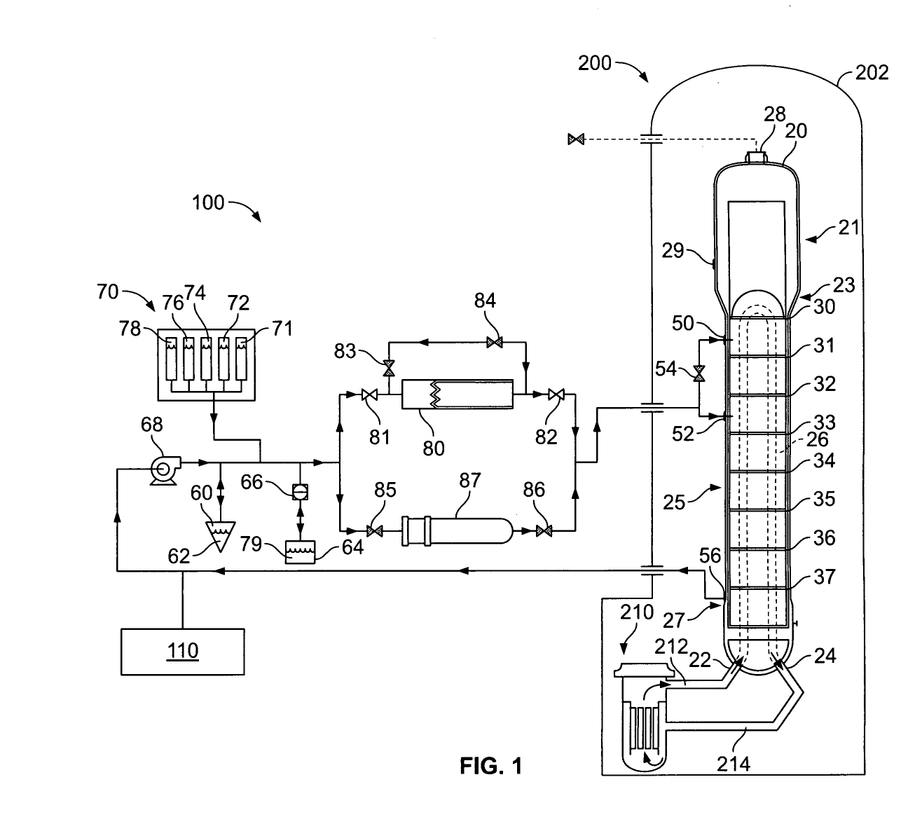

FIG. 1 shows a preferred embodiment of a cleaning system 100 for a nuclear power plant, for example, a pressurized water reactor power plant 200, in accordance with the present invention. Pressurized water reactor power plant 200 includes a reactor building 202 housing a pressurized water reactor 210 connected to a steam generator 20, a turbine and a condenser. Reactor 210 is connected to a steam generator 20 via legs 212, 214. Leg 212 carries heated pressurized water to an inlet 22 in steam generator 20. The heated pressurized water travels through a plurality of tubes 26 until reaching an outlet 24. Leg 214 carries the pressurized water from outlet 24 back to reactor 210 thus defining a primary cooling loop. Steam generator 20 also includes a steam outlet 28 transporting steam to the turbine and an inlet 29 for receiving feedwater during operation which boils due to transfer of heat from the primary cooling loop, thus defining a steam or secondary side of steam generator 20.

Steam generator 20 includes plurality of tubes 26 supported by tube support plates 30, 31, 32, 33, 34, 35, 36, 37. Tube support plates may be designed to support tubes 26 in a variety of ways including, for example, a lattice arrangement or broach arrangement. U.S. Pat. Nos. 4,579,304, 6,059,022 and 6,498,827, hereby incorporated by reference herein, disclose tube support plates including lattice and broach tube support plates.

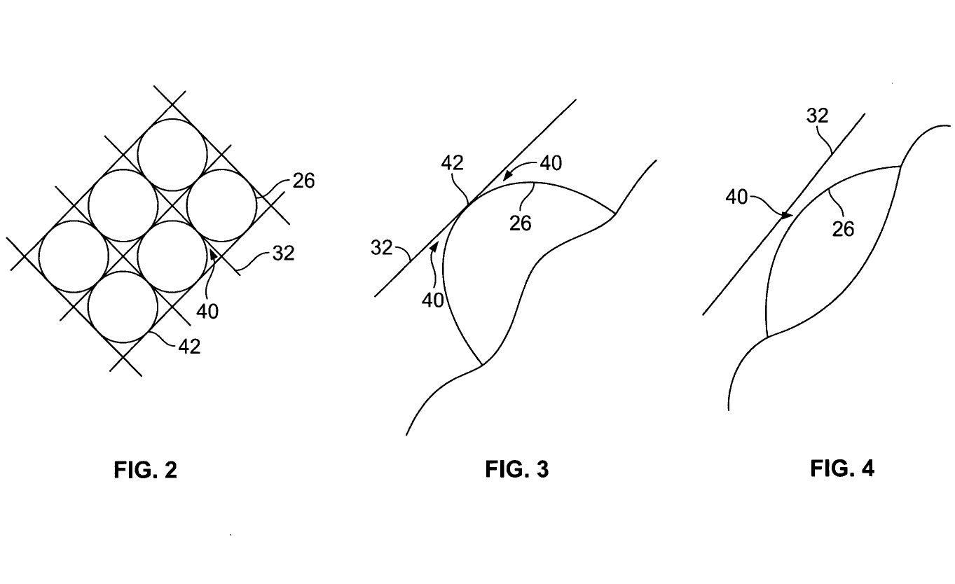

As shown in FIGS. 2 and 3 tube support plate 32 supports tubes 26. Tubes 26 contact support plate 32 at contact points 42. Tube support plate 32 and tubes 26 define crevices 40 in close proximity to contact points 42. Furthermore, as shown in FIG. 4 a crevice 40 may be defined by tube support plate 32 and tube 26 when there is no contact between tube support plate 32 and tube 26. Clearance between tube support plate 32 and tube 26 varies depending upon design of tube support plate 32. In FIGS. 2 to 4 design of tube support plate 32 will influence the size and shape of crevice 40. As steam generator 20 operates, crevices 40 become packed with debris, for example, magnetite and other metal oxide deposits. The packed crevices may become detrimental to the operational life of the steam generators and should be removed prior to damage. The amount of debris accumulated in the crevices may also be referred to as “loading”.

Referring back to FIG. 1, cleaning system 100 includes steam generator 20, a recirculation 68 pump, solvent tank 70, storage reservoir 64, and heater 80. Steam generator 20 includes an upper shell 21, lower shell 25 and transition cone 23. Tubes 26 run up and down lower shell 25 and transition cone 23. Tube support plates 30, 31 . . . 37 are arranged at selected intervals throughout lower shell 21 and up to transition cone 23. Arrangement of tube support plates 30, 31 . . . 37 may vary by design.

Steam generator 20 also includes two inlets 50, 52 for filling steam generator 20 with a solvent. Inlets 50, 52 are located near or at the top of shell 25. Upper inlet 50 is located below tube support plate 30, while lower inlet 52 is located below tube support plate 32. A valve 54 may be turned on and off to control which inlet is used to fill generator 20. An outlet 56 is located below tube support plate 37. Piping when connected to either inlet 50 or 52 and outlet 56 defines a closed solvent loop.

Steam generator 20 is cleaned during an outage of power plant 200. Power plant 200 maintains the secondary side of steam generator 20 under enough nitrogen pressure to prevent boiling of rinsing agent and solvent throughout cleaning. Nitrogen pressure also may be used to assist in raising and lowering levels of the rinsing agent or solvent during cleaning.

Before crevice cleaning, it is preferable to perform bulk cleaning to rid steam generator 20 of any bulk debris that may be covering the crevice areas.

To begin crevice cleaning, a full volume rinse first is completed. Rinsing agent 62 enters cleaning system 100 via a two-way infeed/bleed line 60. Rinsing agent 62 may be primarily water and include, for example, hydrazine and ammonia. The rinsing agent 62 is heated to a target temperature, for example, about 200° F., by heater 80. The target temperature range may include 175° F. to 250° F. Valve 54 may be positioned to allow rinsing agent 62 to fill steam the second side of generator 20 via inlet 50 or inlet 52. Enough rinsing agent 62 is used to fill the secondary side of steam generator 20. Rinsing agent 62 is held in steam generator 20 until components of steam generator 20 including tube support plates 30, 31 . . . 37 and tubes 26 reach a target temperature, for example, about 200° F. Once the target temperature is reached, steam generator 20 is drained completely via outlet 56. A recirculation pump 68 assists in pumping rinsing agent 62 to infeed/bleed line 60. Infeed/bleed line 60 removes rinsing agent 62 from further circulation in cleaning system 100. In addition, a series of low volume rinses may be performed to lower residual heel in a bottommost section 27 of generator 20.

A solvent tank 70 supplies solvent to cleaning system 100. The solvent 79 may include for example, hydrazine, ethylenediaminetetraacetic acid (hereinafter EDTA), CCI-801, ammonium hydroxide and water. Hydrazine is used as a reducing agent to place iron ions in the correct form for optimum dissolution with EDTA. The amount of hydrazine may be set at a level of, for example, 10 grams/liter.

EDTA is a chelating agent used for cleaning steam generator 20. For example, about 20% of solvent 79 may be EDTA. A preferred range of EDTA includes 150 to 250 grams/liter. The amount of EDTA may be based on loading in the steam generator.

CCI-801, as it is known in the trade, is a corrosion inhibitor for slowing reactions between EDTA and metal surfaces of tubes 26 and tube support plates 30, 31 . . . 37. CCI-801 is available from Baker Petrolite of Sugarland, Tex. CCI-801 is preferably present in amounts including 10 to 20 ml/liter. Ammonium hydroxide may be used to adjust the pH of solvent 79. A preferred pH for solvent 79 is, for example, about 7. The remainder of solvent 79 includes water.

As shown in the preferred embodiment, solvent tank 70 includes five component tanks 71, 72, 74, 76, 78. Each component tank 71, 72, 74, 76, 78 may include a different component of solvent 79. For example, component tank 71 includes hydrazine, component tank 72 includes EDTA, component tank 74 includes CCI-801, component tank 76, ammonium hydroxide and component tank 78 includes water. The components from each component tank 71, 72, 74, 76, 78 are combined to form solvent 79.

Fresh solvent 79 from solvent tank 70 may be heated by heater 80 or bypass heater 80 depending upon an arrangement of valves 81, 82, 83, 84. As shown in FIG. 1, valves 81 and 82 are open while valves 83 and 84 are closed, so solvent 79 passes through heater 80. However, solvent 79 may not need to be heated to target temperature. Components of steam generator 20 will heat solvent 79 when solvent 79 enters steam generator 20. Solvent 79 may be heated as desired to remain within a desired temperature range, for example, 175° F. to 250° F. Any solvent 79 above 250° F. may be cooled by cooler 87 before being drained to storage reservoir 64, used for cleaning or transported elsewhere. Controller 110 may monitor the temperature of solvent 79 for example, via sensors, and controller 110 controls the position of valves 54, 81, 82, 83, 84, 85, 86. Valves 54, 81, 82, 83, 84, 85, 86 may also be designed for manual operation.

Valve 54 may be opened to allow solvent 79 to enter via inlet 50. Solvent 79 fills the secondary side of steam generator 20 until tube support plate 30 is submersed in solution. It is preferable for solvent 79 to be at a level, for example, approximately six inches, above tube support plate 30. Solvent 79 begins dissolving material in packed crevices. After a desired amount of time, solvent 79 is drained via outlet 56 and pumped to storage reservoir 64 via recirculation pump 68 and pump 66. Solvent 79 is drained to a second level, for example, approximately six to twelve inches, below tube support plate 30. The amount of time tube support plate 30 is submersed in solution and the fill and drain levels vary depending upon, for example, loading, design and profile of steam generator, corrosion, and design of tube support plates. Furthermore, tube support plates 30, 31, 32 located above inlet 52, for example, typically have a lower corrosion allowance, thus exposure to solvent 79 may be limited or varied based on vertical location of tube support plates 30, 31 . . . 37.

Solvent 79 is then pumped back into the secondary side of steam generator 20 to a third level, for example, approximately 6 inches, above tube support plate 30. The same solvent 79 used to fill steam generator 20 initially is continuously circulated throughout cleaning system 100. Solvent 79 does not reach saturation via crevice cleaning and, as such, retains dissolution abilities when used to refill steam generator 20. By targeting packed crevices through filling and draining, the dissolution capacity of solvent 79 may be maximized.

The process of filling the secondary side of steam generator 20 to a first level above tube support plate 30, draining steam generator 20 to a second level below tube support plate 30 and refilling steam generator 20 to a third level above tube support plate 30 is repeated as desired. Filling and draining may be completed as quickly as possible to maximize the advantages of flushing solvent 79 through packed crevices. Some steam generator designs may require, for example, five to ten cycles of filling and draining to clean packed crevices. Draining steam generator 20 may take approximately 10 minutes and solvent 79 may be held in generator 20 for approximately 15 minutes, allowing about two cycles per hour. However, the exact parameters of each fill and drain cycle are site specific.

After tube support plate 30 is sufficiently cleaned, steam generator 20 is drained via outlet 56 to a level below tube support plate 31. The process stated above is repeated with respect to tube support plate 31. Generator 20 is filled with solvent 79 via inlet 50 to a level above tube support plate 31; excess solvent 79 is kept in storage reservoir 64. After a desired time, solvent 79 is drained to a level below tube support plate 31. Generator 20 is refilled with solvent 79 to a level above tube support plate 31. Pump 66 controls the inflow and outflow of solvent 79 into cleaning system 100 as needed.

After tube support plate 31 is sufficiently cleaned, steam generator 20 is drained via outlet 56 to a level below tube support plate 32. The process stated above is repeated with respect to tube support plate 32.

After tube support plate 32 is sufficiently cleaned, steam generator 20 is drained via outlet 56 to a level below tube support plate 33. Valve 54 is switched into the closed position so filling occurs via inlet 52. The process stated above is repeated until remaining tube support plates 33, 34, 35, 36, 37 have been cleaned. Once tube support plate 37 has been cleaned, solvent 79 is drained from steam generator 20.

Filling via inlet 52 may be advantageous to reduce the amount of time tube support plates 30, 31, 32 are exposed to solvent 79 thereby minimizing corrosion in areas that may be more sensitive. Furthermore, replenishing solvent from the top of generator 20 maximizes the time solvent 79 submerges lower support plates typically subject to the heaviest loading and sludge pile.

Furthermore, steam generator 20 may be cleaned in a bottom to top fashion, thus cleaning tube support plate 37 first and tube support plate 30 last. Solvent 79 is first filled to a level above tube support plate 37. After a desired time, solvent 79 is drained to a level below tube support plate 37 and pumped to storage reservoir 64. Solvent 79 is then pumped back into steam generator 20 to a level above tube support plate 37. The process of filling steam generator 20 to a first level above tube support plate 37, draining steam generator 20 to a second level below tube support plate 37 and refilling steam generator 20 to a third level above tube support plate 37 is repeated as desired.

After tube support plate 37 is sufficiently cleaned, solvent 79 in steam generator 20 is raised to a level above tube support plate 36, the next tube support plate being cleaned. The process stated above is repeated until remaining tube support plates 35, 34, 33, 32, 31, 30 have been cleaned. Once tube support plate 30 has been cleaned, solvent 79 is drained from steam generator 20.

The flushing back and forth above and below the tube support plates can aid in a physical removal of debris as well as removal via chemical solvent. Boiling is not required. By eliminating boiling, the release of gases, including ammonia, to the atmosphere is reduced. Raising and lowering the chemical solvent can cause the nitrogen used for overpressure to move into the condenser and not the atmosphere, reducing or eliminating the need to vent into the atmosphere.

Inlets and outlets may be connected to hand holes pre-existing in steam generators. This cleaning system may be designed to work with the specifications of each specific power plant.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method for cleaning crevices between a plurality of tubes and a plurality of tube support plates supporting the tubes in a steam generator comprising the steps of:
filling a secondary side of the steam generator with a solvent to a first level above a first tube support plate to be cleaned;
draining the solvent to a second level lower than the first tube support plate; and
refilling the secondary side of the steam generator with the solvent to a third level above the first tube support plate.

2. The method as recited in claim 1 further comprising the step of pressurizing the secondary side of the steam generator to prevent boiling of the solvent.

3. The method as recited in claim 1 further comprising the step of heating a plurality of steam generator components to a desired temperature before filling the secondary side of the steam generator with the solvent to the first level.

4. The method as recited in claim 3 wherein the desired temperate ranges between 175° F. and 250° F.

5. The method as recited in claim 1 wherein the solvent includes EDTA, hydrazine, CCI-801, ammonium hydroxide and water.

6. The method as recited in claim 5 wherein the solvent includes approximately 20% EDTA.

7. The method as recited in claim 5 wherein the solvent includes about 150 to 250 g/liter of EDTA.

8. The method as recited in claim 5 wherein the solvent includes 10 ml/liter of hydrazine.

9. The method as recited in claim 5 wherein the solvent has a pH of approximately 7.

10. The method as recited in claim 5 wherein the solvent includes approximately 10 to 20 ml/liters of CCI-801.

11. The method as recited in claim 1 wherein the steps of filling the secondary side of the steam generator to the first level, draining the solvent, and refilling the secondary side of the steam generator to the third level are repeated five to ten times.

12. The method as recited in claim 1 wherein the first level and the third level are the same.

13. The method as recited in claim 1 wherein the first level is approximately six inches above the first tube support plate being cleaned, the second level is six to twelve inches below the first tube support plate being cleaned, and the third level is approximately six inches above the first tube support plate being cleaned.

14. The method as recited in claim 1 further comprising the steps of:
draining the solvent to a fourth level lower than a second tube support plate to be cleaned; and
refilling the secondary side of the steam generator with the solvent to a fifth level above the second tube support plate.

15. The method as recited in claim 14 wherein the fifth level is lower than the first tube support plate.

16. The method as recited in claim 1 further comprising the steps of:
raising the third level of solvent to a fourth level above a second tube support plate to be cleaned; and
draining the solvent to a fifth level lower than the second tube support plate to be cleaned.

17. The method as recited in claim 16 wherein the fifth level is above the first tube support plate.

18. A cleaning system for cleaning crevices between a plurality of tubes and a plurality of tube support plates supporting the tubes in a steam generator comprising:
at least one inlet and at least one outlet connected to the steam generator for filling a secondary side of the steam generator to a first level above a tube support plate and draining the secondary side of the steam generator to a second level below the tube support plate respectively;
a closed solvent loop;
a storage reservoir for adding and removing the solvent from the closed solvent loop to alter the level of the solvent in the secondary side of the steam generator; and
a recirculation pump pumping the solvent through the cleaning system.

19. The cleaning system as recited in claim 18 further comprising a heater for heating the solvent to a desired temperature.

20. The cleaning system as recited in claim 18 further comprising a rinsing agent tank for storing a rinsing agent.

21. The cleaning system as recited in claim 18 further comprising a cooler to cool the solvent as desired.

22. The cleaning system as recited in claim 18 further comprising a further inlet for filling the secondary side of the steam generator with the solvent.

23. The cleaning system as recited in claim 18 further comprising a solvent tank for adding the solvent to the closed solvent loop.

24. A pressurized water reactor nuclear power plant comprising:
a pressurized water reactor;
a steam generator connected to the pressurized water reactor; and
the cleaning system as recited in claim 18.
